(19) United States
(12) Patent Application Publication
(10) Pub. No.: US 2021/0198150 A1
(43) Pub. Date: Jul. 1, 2021

(54) SILKY, FINE-GRAINED MATTE CERAMIC TILE AND PREPARATION METHOD THEREOF

(71) Applicants: DONGGUAN CITY WONDERFUL CERAMICS INDUSTRIAL PARK CO., LTD., Dongguan, Guangdong (CN); JIANGXI HEMEI CERAMICS CO., LTD., Yichun, Jiangxi (CN); CHONGQING WONDERFUL CERAMICS CO., LTD., Chongqing (CN); JIANGXI WONDERFUL CERAMICS CO., LTD., Yichun, Jiangxi (CN); GUANGDONG JIAMEI CERAMICS CO., LTD., Qingyuan, Guangdong (CN)

(72) Inventors: Zhanwen Gu, Dongguan, Guangdong (CN); Yanjun Wang, Dongguan, Guangdong (CN); Jiangwen Deng, Dongguan, Guangdong (CN); Huiyin Xiao, Dongguan, Guangdong (CN); Quan Yang, Dongguan, Guangdong (CN); Chaoxian Pan, Dongguan, Guangdong (CN); Yongqiang Wang, Dongguan, Guangdong (CN); Xuebin Liu, Dongguan, Guangdong (CN); Junjun Jiang, Dongguan, Guangdong (CN); Jun Wang, Dongguan, Guangdong (CN)

(21) Appl. No.: 16/762,916

(22) PCT Filed: Jun. 25, 2019
(86) PCT No.: PCT/CN2019/092693

§ 371 Date: May 9, 2020

(30) Foreign Application Priority Data
Apr. 8, 2019 (CN) 201910277756.3

(51) Int. Cl. C04B 33/13; C04B 33/132; C04B 33/30; C04B 33/34; C04B 41/00; C04B 41/50; C04B 41/52; C04B 41/89; C03C 8/02; C03C 8/04; B28B 3/02; B28B 11/04; B28B 11/24

(52) U.S. Cl. CPC C04B 33/1315; C03C 2205/00; C04B 33/1321; C04B 33/30; C04B 33/34; C04B 41/009; C04B 41/5022; C04B 41/522; C04B 41/89; C03C 8/02; C03C 8/04; B28B 3/02; B28B 11/044; B28B 11/243; C04B 2235/3472; C04B 2235/349; C04B 2235/3463; C04B 2235/448; C04B 2235/604; C04B 33/1324

(57) ABSTRACT

The invention involves a silky, fine-grained matte ceramic tile and its preparation method. A blank material for the ceramic tile consists of the following components: nepheline powder: 10%-15%; high-carbon mud: 10%-15%; low-carbon mud: 15%-22%; medium-high-carbon mud: 10%-15%; recycled waste blank: 5%-10%; feldspar powder: 5%-10%; albite powder for paving: 12%-20%; waste porcelain powder: 5%-10%; desulfurized waste: 0%-7%; waste from edging and polishing: 15%-26%; liquid gel remover: 0.3%-1.0%; liquid reinforcing agent: 0.2%-0.8%. Its preparation method comprises the following steps: preparing raw materials for a blank body and ball milling→spray drying→aging→pressing and molding of the blank body→drying→polishing the blank body→spraying water→applying a glaze→applying a decorative pattern→firing.

### FIELD OF THE INVENTION

This invention relates to the field of ceramic production, and in particular to a silky, fine-grained matte ceramic tile and a preparation method thereof.

### BACKGROUND OF THE INVENTION

CN201710408570.8 discloses a matte raw material glaze, its preparation method, and its application. The objective is to eliminate undesirable features from a matte glaze product, such features include a texture that is rough to the touch, unstable corrosion resistance, and poor color development of the inkjet ink. Its technical solution is as follows: the method for preparing the matte raw material glaze includes the following steps: taking 1 to 5 parts of zinc oxide, 15 to 35 parts of barium carbonate, 15 to 30 parts of potassium feldspar, 0 to 10 parts of sodium feldspar, 0-10 parts of dolomite, 3-10 parts of kaolin, 4-15 parts of quartz, and 4-15 parts of calcium phosphate (all in parts by mass); then, adding sodium tripolyphosphate and carboxymethyl cellulose, followed by 50-70 parts of water; ball grinding until the material is able to pass a 325 mesh sieve; aging for more than 24 hours to obtain the product. A drawback of this method is that the preparation process is relatively complicated. In the methods disclosed by CN201110292141.1, CN201310076559.8, CN201710408570.8, CN201710321330.4, CN201810053256.7, among others, various amounts of barium carbonate, strontium compounds, tin oxide, or titanium dioxide are included in the glaze formulation. These materials have different degrees of toxicity and may easily affect the physical and mental health of human beings during use. On Oct. 27, 2017, the International Agency for Research on Cancer of the World Health Organization published a list of carcinogens, and titanium dioxide is classified as category 2B carcinogen. Besides, the glaze contains titanium dioxide, which contributes to the yellow color that appears on the glazed surface of the product, affecting the richness of the decorative pattern.

### SUMMARY OF THE INVENTION

### Technical Problem

The objective of the present invention is to provide an environmentally friendly method for preparing a silky, fine-grained matte ceramic tile. The method involves a one-time glazing method, which reduces the consumption of glaze material, reduces the likelihood of developing product defects, simplifies the production process, and reduces production difficulty. Raw materials with relatively small impacts on health and safety are used, and a variety of solid wastes are consumed in this process.

### Technical Solution

The technical solution of the present invention is a silky, fine-grained matte ceramic tile, wherein a blank material for the ceramic tile consists of the following components in weight percentages:

| nepheline powder: | high-carbon mud: | low-carbon mud: |
|---|---|---|
| 10%-15% | 10%-15% | 15%-22% |
| medium-high-carbon | recycled waste blank: | feldspar powder: |
| mud: 10%-15% | 5%-10% | 5%-10% |
| albite powder for | desulfurized waste: | waste from edging and |
| paving: 12%-20% | 0%-7% | polishing: 15%-26% |
| waste porcelain powder: | liquid gel remover: | liquid reinforcing |
| 5%-10% | 0.3%-1.0% | agent: 0.2%-0.8%. |

As a preferred embodiment, the waste from edging and polishing is one or more selected from the group consisting of SiO₂, Al₂O₃, CaO, K₂O, Na₂O, MgO, MgCl₂, and SiC; the waste from edging and polishing has a water content of 32% to 36%.

As a preferred embodiment, the liquid gel remover is one or more selected from the group consisting of methacrylic acid, sodium methallylsulfonate, sodium persulfate, hydroquinone, polyimide, sodium hydroxide, sodium chloride, and sodium carbonate; the liquid gel remover has a pH of 7.0 to 9.0.

As a preferred embodiment, the liquid reinforcing agent is one or more selected from the group consisting of modified lignin, polyvinyl alcohol, polyacrylate, sodium polyacrylate, water glass, and a phosphate salt.

Another technical solution of the present invention is a method for preparing the silky, fine-grained matte ceramic tile, wherein it comprises the following steps:

(1) preparing raw materials for a blank body: preparing the raw materials according to a predetermined ratio, feeding the raw materials directly into a three-stage continuous ball mill, adding water at a ratio of 32% to 35% of a water content of a slurry, and ball milling continuously for 2 to 5 hours; the raw materials include waste from edging and polishing, desulfurized waste, waste porcelain powder, nepheline powder, feldspar powder, albite powder for paving, high-carbon mud, and low-carbon mud;

(2) spray drying: storing a slurry produced by the continuous ball mill in an underground slurry tank; transferring the slurry into a drying tower by a plunger pump for powder spray granulation after aging and homogenization; unit weight: 1.0 to 1.1, water content: 6.0% to 6.5%;

(3) aging: conveying powder from the spray drying to a powder silo directly with a belt, aging the powder in the powder silo for more than 48 hours before pressing and molding; water content: 5.0% to 6.0%;

(4) pressing and molding of the blank body: transporting the powder for the blank body to a hopper provided at the top of a press after aging; pushing the powder for the blank body into a mold frame of the press by a grid distributor; allowing the blank body to form a set shape by pressing of the press, during which part of a gas in a void in the powder for the blank body is discharged, the powder for the blank body shift and gradually move closer, and is firmly combined together by internal friction; the shape of the blank body formed has a cross-section identical to a cross-section of a mold, and an upper surface shape and a lower surface shape determined by shapes of an upper press mold and a lower press mold in the mold frame;

(5) drying: drying the blank body in a roller hearth furnace having 3 to 5 layers; a maximum drying temperature is 160 to 200° C., drying time is 30 to 60 min; strength of the blank body after drying is 1.2 Mpa to 1.8 Mpa, a water content of a dried blank body is <0.1%;

(6) polishing the blank body: polishing a surface of the blank body coming out from the roller hearth furnace by a blank body polishing machine;

(7) spraying water: spraying water onto the surface of the blank body by a high-pressure water-spraying cabinet that is provided with a spray gun; a nozzle of the spray gun has a size of 0.36 mm; water pressure during spraying is 12 bar to 18 bar, water spraying volume is 55 g/m² to 100 g/m²;

(8) applying a glaze: applying the glaze through a linear glazing machine; process parameters are as follows: specific gravity of a glaze slurry is 1.45 to 1.80, a flow rate of the glaze slurry is 18 S to 30 S, a thickness of a glaze layer is 0.03 mm to 0.1 mm;

(9) applying a decorative pattern: applying a decorative pattern to a glazed surface of the blank body via any one of screen printing, rubber rolls for printing, or inkjet printing;

(10) firing: transferring a product from the previous step to a firing kiln for firing at a firing temperature of 1050° C. to 1170° C. and a firing time of 50 to 80 min, wherein a firing time for a middle-and-high-temperature stage is 6 to 10 min.

As a preferred embodiment, the desulfurized waste in step (1) is a desulfurized plaster produced by treating smoke from a ceramic tile kiln via a wet desulfurization process; a main component of the desulfurized plaster is calcium sulfate dihydrate CaSO₄.2H₂O, a major impurity is calcium carbonate; the desulfurized plaster has a purity of 90% to 95%, a water content of 10% to 15%, and a main particle size of 30 nm to 50 nm.

As a preferred embodiment, the high-carbon mud in step (1) has a carbon content of ≥3.0%, it needs to be used in combination with the low-carbon mud, and it has a water content of 19% to 21%; the low-carbon mud has a carbon content of ≤0.5%, it can be used independently as a component of the raw materials, or in combination with a medium-high-carbon mud, and it has a water content of 17% to 20%.

As a preferred embodiment, the glaze in step (8) is a silky matte glaze slurry consisting of a leveling agent and a fine-grained matte glaze slurry;

the leveling agent is one or more selected from the group consisted of a polyacrylic acid leveling agent, a phosphate ester modified acrylic acid leveling agent, a fluorine modified acrylic acid leveling agent, a butyl acrylate leveling agent, a silicone leveling agent, a polyether polyester modified silicone leveling agent, a polyether-modified silicone, a polymethylalkylsiloxane, an alkyl-modified organosiloxane, an end-group modified silicone, and a fluorocarbon leveling agent; the leveling agent is added in an amount of 0.1% to 0.5% in weight percentage;

the fine-grained matte glaze slurry is made from ball-milling 64%-74% of a matte glaze powder, 0.2%-1.2% of an additive, and 25%-35% of water in weight percentages for 5 to 8 hours; fineness of the fine-grained matte glaze slurry is controlled such that 0.8%-1.2% of the fine-grained matte glaze slurry is unable to pass a 325 mesh sieve.

As a preferred embodiment, the matte glaze powder consists of the following components in weight percentages:

| nepheline: | albite: | FMC633 frit: |
|---|---|---|
| 8%-13% | 5%-10% | 10%-15% |
| FMC689 frit: | FMC053 frit: | zinc phosphate: |
| 28%-35% | 8%-12% | 2%-10% |
| zinc oxide: | wollastonite: | aluminium oxide: |
| 2%-6% | 2%-5% | 1%-7% |
| bentonite: | ultrafine zirconia: | recycled material from |
| 0%-1% | 0%-10% | scrapping: 5%-15% |
| ball clay: | carboxymethyl cellulose: | sodium tripolyphosphate: |
| 7%-10% | 0.2%-0.3% | 0.3%-0.5%. |

As a preferred embodiment, calcium and magnesium are introduced into a formulation of the FMC633 frit; the FMC633 frit comprises the following main chemical components in weight percentages:

| | | |
|---|---|---|
| I.L ≤ 0.05; | SiO₂: 51.35; | Al₂O₃: 11.97; |
| Fe₂O₃: 0.05; | CaO: 17.92; | MgO: 8.25; |
| K₂O: 2.86; | Na₂O: 2.39; | ZrO₂: 5.16; |

the FMC633 frit is a low-temperature frit which is conducive to the formation of a smooth product glaze with a crystal-like gloss;

aluminium and calcium are introduced into a formulation of the FMC689 frit; the FMC689 frit comprises the following main chemical components in weight percentages:

| | | |
|---|---|---|
| I.L ≤ 0.05; | SiO₂: 54.52; | Al₂O₃: 21.73; |
| Fe₂O₃: 0.07; | CaO: 15.11; | MgO: 0.23; |
| K₂O: 3.49; | Na₂O: 2.43; | B₂O₃: 1.89; |
| ZnO: 0.48; | | |

the FMC689 frit is a high-temperature frit, which allows the formation of a smooth product glaze and controls the gloss of the product glaze;

zinc and zirconium are introduced into a formulation of the FMC053 frit; the FMC053 frit comprises the following main chemical components in weight percentages:

| | | |
|---|---|---|
| I.L ≤ 0.05; | SiO₂: 44.67; | Al₂O₃: 16.36; |
| Fe₂O₃: 0.05; | CaO: 4.1; | MgO: 0.30; |
| K₂O: 1.76; | Na₂O: 2.72; | B₂O₃: 2.59; |
| ZnO: 15.03; | ZrO₂: 11.20; | P₂O₅: 1.17; |

the FMC053 frit is a medium high-temperature frit, which allows the formation of a smooth and fine product glaze and whitens the product glaze;

the recycled material from scrapping consists of a blank material and a glaze material, wherein the glaze material comprises a base glaze and a transparent glaze, the recycled material from scrapping has a water content of 9% to 13% and fineness of <1%; the recycled material from scrapping comprises the following main chemical components in weight percentages:

| | | |
|---|---|---|
| IL.: 5-6; | SiO₂: 59-61; | Al₂O₃: 20-21; |
| Fe₂O₃: 0.1-0.2; | CaO: 4.5-5; | MgO: 3-3.8; |
| K₂O: 1-1.5; | Na₂O: 2.5-3; | ZrO₂: 0.2-0.8; |

the ultrafine zirconia has a D50 value kept below 0.47 μm and a D90 value kept below 1.0 μm, ZrO₂ ≥93.27%, refractive index: 1.93 to 2.01, melting point: 2370 to 2700° C.

### Beneficial Effects

(1) In the preparation process of the present invention, raw materials with relatively little impact on health and safety are used, and a large number of solid wastes are consumed. This is environmentally friendly and creates economic benefits through recycling. A one-time glaze application method is adopted, which reduces the consumption of glaze, reduces the likelihood of developing product defects, simplifies the production process, and reduces production difficulty.

(2) In the present invention, the blank body is allowed to have a smooth surface through adjusting the fineness and water content of the slurry, the grain composition of the powder, and the bulk density (which indicates the compactness of the powder), and employing a uniform material distribution technique and a blank polishing technique, etc. The silky matt glaze material comprises a combination of a number of frits; at high temperatures, the frits turn into a liquid phase having good fluidity, which is able to efficiently assist the melting of the other materials, allowing fast leveling. Meanwhile, the firing range of the product is also greatly expanded, allowing the product to be fired in different kilns under different process conditions. The glazed surface of the product could develop a silky, fine-grained texture more easily. The gloss of the glazed surface is 9-15 degrees.

(3) The smoothness of the glazed surface and the quality of the product of the present invention are superior to the other products in the same category. The chemical corrosion resistance and pollution resistance of the products of the present invention match the highest level of Chinese national standard. Any blue ink, red ink, black ink, water-based or oil-based markers contaminating the glazed surface could be easily wiped away; these glazed surfaces can be easily cleaned and are stain-resistant. Wear resistance of the product matches Chinese national quality control standards. We use the term “wear” to quantitatively characterize the wear resistance of the product. The wear of the product produced according to the method of the present invention is less than 0.25 g/m³ (the wear extent of the product at 12,000 rpm).

(4) The recycled material from scrapping used the present invention is the raw material obtained by scraping the glazed edges of the blank body that is advancing on the conveyor line after the glazing process and before firing in the kiln. The scraping of the glazed edge of the blank body is to prevent the glaze on the edges of the blank body from turning into a flowing liquid-phase glaze during high-temperature firing—the liquid-phase glaze may adhere to the roller to form a nail, which may scratch or lift the product being fired in the kiln, resulting in cracks, central cracks, wave deformation and other defects of the product.

(5) The bentonite and ball clay used in the present invention have fine particle sizes, and good thickening effect, suspension stability, lubricity, film-forming abilities, water resistance, high-temperature stability, and chemical stability. They give rise to a high degree of whiteness after firing and allow the glaze slurry to have a desirable suspension property. As a result, the glaze is smooth and has a good covering ability. The bentonite and ball clay strengthen the connection between the glaze and blank, reduce the number of defects on the glazed surface.

(6) The leveling agent in the silky matt glaze of the present invention has the following characteristics: smooth, anti-stick, wet, low surface tension, fast leveling speed, and good miscibility with the glaze slurry. After being added to the glaze slurry at a certain ratio, it significantly reduces the surface tension of the glaze slurry system and improves the flowing and leveling abilities of the system, and could defoam. During the drying of the silky matte slurry paste on the surface of the blank body, the leveling agent quickly eliminates defects such as sand holes, shrinkage cavities, pinholes, orange peel on surfaces, and craters, thereby promotes the formation of a flat, smooth and uniform glaze film. In this way, the glazed surface is smoother and has a silky, mirror-like touch and gloss.

(7) The liquid reinforcing agent used in the present invention increases the dry strength of the blank body, ensures that the tile is not prone to cracking before entering the kiln. In addition, the liquid reinforcing agent is able to completely evaporate at medium and high temperatures without affecting the quality of the ceramic tile product, i.e., the formation of molten holes, bubbles, color differences, deformation, among others, is prevented.

(8) The grid distributor used in the present invention has an adjustable bolt locking mechanism on its frame to ensure a uniform powder thickness at all directions within the frame. In addition, spring steel is provided on the frame in contact with the surface of the mold frame, which allows the grid distributor to be in full flexible contact with the surface of the mold frame of the press. In this way, the grid distributor is no longer prone to deformation loaded with heavy powder materials during operation, leading to more uniform material distribution. The surface of the grids of the grid distributor is coated with PTFE to prevent the powder for the blank body from sticking to the grid distributor and disturbing material distribution. This greatly increases the production rate and distribution uniformity.

(9) The hopper provided at the top of the press is installed with a powder homogenizer at its middle. The powder homogenizer consists of an upper funnel and a lower funnel. The upper funnel and the lower funnel are installed in opposite orientations at a distance of 10-20 cm from each other; that is, the large mouth (the diameter of which is ⅓-⅖ of the diameter of the hopper at the top of the press) of the upper funnel is facing up, and the small mouth (the diameter of which is ⅛-⅙ of the diameter of the hopper at the top of the press) of the upper funnel is facing down, and is fixed to the center of the hopper at the top of the press via an iron frame. The small mouth (the diameter of which is 1/12- 1/10 of the diameter of the hopper at the top of the press) of the lower hopper is facing up, the large mouth (the diameter of which is ⅙-¼ of the diameter of the hopper at the top of the press) of the lower hopper is facing down, and is fixed directly above the cross center of stainless steel partitions in the hopper. When the conveyor belt sends the same material falling from different silos to the top of the hopper at the top of the press through an inclined hopper, the material can be evenly distributed to each small silo compartment through the powder homogenizer to homogenize the powder before pressing. This allows the powder to have consistent humidity and grain composition during pressing, which increases the smoothness of the blank surface and the compactness and uniformity of the blank body, while reduces defects such as sandwiched layers and bulging in the blank body.

(10) In the present invention, by setting a number of polishing groups, the tiles are gradually cut and polished to reach a desirable cutting and polishing volume. Setting multiple polishing groups ensures that the dried blank body has a smoother surface while reducing damages to the tile.

### DETAILED DESCRIPTION OF THE ILLUSTRATED EMBODIMENTS

### The Most Preferred Embodiment of the Present Invention

The present invention will be described in further detail below with embodiments.

The blank material for the silky, fine-grained matte ceramic tile consists of the following components in weight percentage:

| nepheline powder: | high-carbon mud: | low-carbon mud: |
|---|---|---|
| 10% | 8% | 15% |
| medium-high-carbon | recycled waste blank: | feldspar powder: |
| mud: 11% | 7% | 5% |
| albite powder for paving: | desulfurized waste: | waste from edging and |
| 15% | 4% | polishing: 17% |
| waste porcelain powder: | liquid gel remover: | liquid reinforcing |
| 7% | 0.5% | agent: 0.5%. |

In the present embodiment, the waste from edging and polishing is one or more selected from the group consisting of SiO₂, Al₂O₃, CaO, K₂O, Na₂O, MgO, MgCl₂, and SiC; the water content of the waste from edging and polishing is 32% to 36%.

The waste from edging and polishing is mainly the solid waste produced during cold working at a later stage of ceramic tile production, that is, after grinding, polishing, edging, chamfering, and other procedures, the solid waste produced during flocculation, sedimentation, pressure filtration, and other processes. This solid waste includes fine particles that are produced during polishing or grinding, that is, fine particles from the grinding of the blank material, the glaze material, and mounted points. The recycled waste blank is from missing corners and mud blanks (not fired) produced during the manufacturing process; these materials are partially dissolved in water to form a slurry or are directly ball-milled to be reused in a mud slurry for the blank. The waste porcelain powder is a material having a desirable particle size obtained after a series of crushing treatments on defective tile products, followed by sieving.

In the present embodiment, the liquid gel remover is one or more selected from the group consisting of methacrylic acid, sodium methallylsulfonate, sodium persulfate, hydroquinone, polyimide, sodium hydroxide, sodium chloride, and sodium carbonate; the pH of the liquid gel remover is 7.0 to 9.0.

In the present embodiment, the liquid reinforcing agent is one or more selected from the group consisting of modified lignin, polyvinyl alcohol, polyacrylate, sodium polyacrylate, water glass, and a phosphate salt.

The liquid reinforcing agent increases the dry strength of the blank body, ensures that the tile is not prone to cracking before entering the kiln. In addition, the liquid reinforcing agent is able to completely evaporate at medium and high temperatures without affecting the quality of the ceramic tile product, i.e., the formation of molten holes, bubbles, color differences, deformation, among others, is prevented.

The method for preparing a silky, fine-grained matte ceramic tile comprises the following steps:

(1) preparing raw materials for a blank body: preparing the raw materials according to a predetermined ratio, feeding the raw materials directly into a three-stage continuous ball mill, adding water at a ratio of 32% to 35% of the water content of a slurry, and ball milling continuously for 2 to 5 hours; the raw materials include waste from edging and polishing, desulfurized waste, waste porcelain powder, nepheline powder, feldspar powder, albite powder for paving, high-carbon mud, and low-carbon mud. The desulfurized waste is a desulfurized plaster produced by treating smoke from a ceramic tile kiln via a wet desulfurization process, the main component of the desulfurized plaster is calcium sulfate dihydrate CaSO₄.2H₂O, the major impurity is calcium carbonate; the desulfurized plaster has a purity of 90% to 95%, a water content of 10% to 15%, and a main particle size of 30 to 50 nm. The high-carbon mud has a carbon content of ≥3.0%, it needs to be used in combination with the low-carbon mud, and it has a water content of 19% to 21%; the low-carbon mud has a carbon content of ≤0.5%, it can be used independently as a component of the raw materials or in combination with a medium-high-carbon mud, and it has a water content of 17% to 20%.

(2) Spray drying: storing a slurry produced by the continuous ball mill in an underground slurry tank; transferring the slurry into a drying tower by a plunger pump for powder spray granulation after aging and homogenization; unit weight: 1.0 to 1.1, water content: 6.0% to 6.5%.

(3) Aging: conveying powder from the spray drying to a powder silo directly with a belt, aging the powder in the powder silo for more than 48 hours before pressing and molding; water content: 5.0 to 6.0%.

(4) Pressing and molding of the blank body: transporting the powder for the blank body to a hopper provided at the top of a press after aging; pushing the powder for the blank body into a mold frame of the press by a grid distributor; allowing the blank body to form a set shape by pressing of the press, during which part of a gas in a void in the powder for the blank body is discharged, the powder for the blank body shifts and gradually moves closer, and is firmly combined together by internal friction; the shape of the blank body formed has a cross-section identical to a cross-section of a mold, and an upper surface shape and a lower surface shape determined by shapes of an upper press mold and a lower press mold in the mold frame.

(5) Drying: drying the blank body in a roller hearth furnace having 3 to 5 layers; a maximum drying temperature is 160 to 200° C., drying time is 30 to 60 min; strength of the blank body after drying is 1.2 Mpa to 1.8 Mpa, a water content of a dried blank body is <0.1%.

(6) Polishing the blank body: polishing a surface of the blank body coming out from the roller hearth furnace by a blank body polishing machine.

(7) Spraying water: spraying water onto the surface of the blank body by a high-pressure water-spraying cabinet that is provided with a spray gun; a nozzle of the spray gun nozzle has a size of 0.36 mm; water pressure during spraying is 12 bar to 18 bar, water spraying volume is 55 g/m² to 100 g/m².

(8) Applying a glaze: applying the glaze through a linear glazing machine; process parameters are as follows: specific gravity of a glaze slurry is 1.45 to 1.80, a flow rate of the glaze slurry is 18 to 30 S, a thickness of a glaze layer is 0.03 to 0.1 mm. The glaze is a silky matte glaze slurry consisting of a leveling agent and a fine-grained matte glaze slurry.

The leveling agent is one or more selected from the group consisted of a polyacrylic acid leveling agent, a phosphate ester modified acrylic acid leveling agent, a fluorine modified acrylic acid leveling agent, a butyl acrylate leveling agent, a silicone leveling agent, a polyether polyester modified silicone leveling agent, a polyether-modified silicone, a polymethylalkylsiloxane, an alkyl-modified organosiloxane, an end-group modified silicone, and a fluorocarbon leveling agent; the leveling agent is added in an amount of 0.1% to 0.5% in weight percentage.

The fine-grained matte glaze slurry is made from ball-milling 64%-74% of a matte glaze powder, 0.2%-1.2% of an additive, and 25%-35% of water in weight percentages for 5 to 8 hours; fineness of the fine-grained matte glaze slurry is controlled such that 0.8% -1.2% of the fine-grained matte glaze slurry is unable to pass a 325 mesh sieve.

The matte glaze powder consists of the following components in weight percentages:

| nepheline: | albite: | FMC633 frit: |
|---|---|---|
| 8% | 5% | 12% |
| FMC689 frit: | FMC053 frit: | zinc phosphate: |
| 32% | 10% | 3% |
| zinc oxide: | wollastonite: | aluminium oxide: |
| 3% | 2% | 2% |
| bentonite: | ultrafine zirconia: | recycled material from |
| 0.3% | 2% | scrapping: 12% |
| ball clay: | carboxymethyl cellulose: | sodium tripolyphosphate: |
| 8% | 0.2% | 0.5%. |

Calcium and magnesium are introduced into a formulation of the FMC633 frit; the FMC633 frit comprises the following main chemical components in weight percentages:

| | | |
|---|---|---|
| I.L: 0.05 | SiO₂: 51.35 | Al₂O₃: 11.97 |
| Fe₂O₃: 0.05 | CaO: 17.92 | MgO: 8.25 |
| K₂O: 2.86 | Na₂O: 2.39 | ZrO₂: 5.16. |

The FMC633 frit is a low-temperature frit that is conducive to the formation of a smooth product glaze with a crystal-like gloss.

Aluminium and calcium are introduced into a formulation of the FMC689 frit; the FMC689 frit comprises the following main chemical components in weight percentages:

| | | |
|---|---|---|
| I.L: 0.05 | SiO₂: 54.52 | Al₂O₃: 21.73 |
| Fe₂O₃: 0.07 | CaO: 15.11 | MgO: 0.23 |
| K₂O: 3.49 | Na₂O: 2.43 | B₂O₃: 1.89 |
| ZnO: 0.48. | | |

The FMC689 frit is a high-temperature frit, which allows the formation of a smooth product glaze and controls the gloss of the product glaze.

Zinc and zirconium are introduced into a formulation of the FMC053 frit; the FMC053 frit comprises the following main chemical components in weight percentages:

| | | |
|---|---|---|
| I.L: 0.05 | SiO₂: 44.67 | Al₂O₃: 16.36 |
| Fe₂O₃: 0.05 | CaO: 4.10 | MgO: 0.30 |
| K₂O: 1.76 | Na₂O: 2.72 | B₂O₃: 2.59 |
| ZnO: 15.03 | ZrO₂: 11.20 | P₂O₅: 1.17. |

The FMC053 frit is a medium high-temperature frit, which allows the formation of a smooth and fine product glaze and whitens the product glaze.

The recycled material from scrapping consists of a blank material and a glaze material, wherein the glaze material comprises a base glaze and a transparent glaze, the recycled material from scrapping has a water content of 9% to 13% and fineness of <1%; the recycled material from scrapping comprises the following main chemical components in weight percentages:

| | | |
|---|---|---|
| IL.: 5 | SiO₂: 60.7 | Al₂O₃: 20.8; |
| Fe₂O₃: 0.1 | CaO: 4.9 | MgO: 3.6; |
| K₂O: 1.2 | Na₂O: 3.0; | ZrO₂: 0.7. |

The ultrafine zirconia has a D50 value kept below 0.47 μm and a D90 value kept below 1.0 μm, ZrO₂≥93.27%, refractive index: 1.93 to 2.01, melting point: 2370° C. to 2700° C.

(9) Applying a decorative pattern: applying a decorative pattern to a glazed surface of the blank body via any one of screen printing, rubber rolls for printing, or inkjet printing.

(10) Firing: transferring a product from the previous step to a firing kiln for firing at a firing temperature of 1050° C. to 1170° C. and a firing time of 50 min to 80 min, wherein a firing time for a middle and high temperature stage is 6 min to 10 min.

### INDUSTRIAL APPLICABILITY

The description above is only the preferred embodiments of the present invention. The specific embodiments above do not limit the scope of the present invention. Various alterations and modifications can be carried out without departing from the spirit of the present invention. Any alterations, modifications, and equivalent substitutions made by a person having ordinary skill in the art all fall within the protection scope of the present invention.

What is claimed is:

1. A silky, fine-grained matte ceramic tile, wherein a blank material for the ceramic tile consists of the following components in weight percentages:
nepheline powder: 10%-15%;
high-carbon mud: 10%-15%;
low-carbon mud: 15%-22%;
medium-high-carbon mud: 10%-15%;
recycled waste blank: 5%-10%;
feldspar powder: 5%-10%;
albite powder for paving: 12%-20%;
desulfurized waste: 0%-7%;
waste from edging and polishing: 15%-26%;
waste porcelain powder: 5%-10%;
liquid gel remover: 0.3%-1.0%;
liquid reinforcing agent: 0.2%-0.8%.

2. The silky, fine-grained matte ceramic tile according to claim 1, wherein the waste from edging and polishing is one or more selected from the group consisting of SiO₂, Al₂O₃, CaO, K₂O, Na₂O, MgO, MgCl₂, and SiC;
the waste from edging and polishing has a water content of 32% to 36%.

3. The silky, fine-grained matte ceramic tile according to claim 1, wherein the liquid gel remover is one or more selected from the group consisting of methacrylic acid, sodium methallylsulfonate, sodium persulfate, hydroquinone, polyimide, sodium hydroxide, sodium chloride, and sodium carbonate;
the liquid gel remover has a pH of 7.0 to 9.0.

4. The silky, fine-grained matte ceramic tile according to claim 1, wherein the liquid reinforcing agent is one or more selected from the group consisting of modified lignin, polyvinyl alcohol, polyacrylate, sodium polyacrylate, water glass, and a phosphate salt.

5. A method for preparing a silky, fine-grained matte ceramic tile, wherein it comprises the following steps:
(1) preparing raw materials for a blank body: preparing the raw materials according to a predetermined ratio, feeding the raw materials directly into a three-stage continuous ball mill, adding water at a ratio of 32% to 35% of a water content of a slurry, and ball milling continuously for 2 to 5 hours; the raw materials include waste from edging and polishing, desulfurized waste, waste porcelain powder, nepheline powder, feldspar powder, albite powder for paving, high-carbon mud, and low-carbon mud;
(2) spray drying: storing a slurry produced by the continuous ball mill in an underground slurry tank; transferring the slurry into a drying tower by a plunger pump for powder spray granulation after aging and homogenization; unit weight: 1.0 to 1.1, water content: 6.0% to 6.5%;
(3) aging: conveying powder from the spray drying to a powder silo directly with a belt, aging the powder in the powder silo for more than 48 hours before pressing and molding; water content: 5.0% to 6.0%;
(4) pressing and molding of the blank body: transporting the powder for the blank body to a hopper provided at the top of a press after aging; pushing the powder for the blank body into a mold frame of the press by a grid distributor; allowing the blank body to form a set shape by pressing of the press, during which part of a gas in a void in the powder for the blank body is discharged, the powder for the blank body shifts and gradually moves closer, and is firmly combined together by internal friction; the shape of the blank body formed has a cross-section identical to a cross-section of a mold, and an upper surface shape and a lower surface shape determined by shapes of an upper press mold and a lower press mold in the mold frame;
(5) drying: drying the blank body in a roller hearth furnace having 3 to 5 layers; a maximum drying temperature is 160° C. to 200° C., drying time is 30 min to 60 min; strength of the blank body after drying is 1.2 Mpa to 1.8 Mpa, a water content of a dried blank body is <0.1%;
(6) polishing the blank body: polishing a surface of the blank body coming out from the roller hearth furnace by a blank body polishing machine;
(7) spraying water: spraying water onto the surface of the blank body by a high-pressure water-spraying cabinet that is provided with a spray gun; a nozzle of the spray gun has a size of 0.36 mm; water pressure during spraying is 12 bar to 18 bar, water spraying volume is 55 g/m² to 100 g/m²;
(8) applying a glaze: applying the glaze through a linear glazing machine; process parameters are as follows: specific gravity of a glaze slurry is 1.45 to 1.80, a flow rate of the glaze slurry is 18 S to 30 S, a thickness of a glaze layer is 0.03 mm to 0.1 mm;
(9) applying a decorative pattern: applying a decorative pattern to a glazed surface of the blank body via any one of screen printing, rubber rolls for printing, or inkjet printing; and
(10) firing: transferring a product from the previous step to a firing kiln for firing at a firing temperature of 1050° C. to 1170° C. and a firing time of 50 min to 80 min, wherein a firing time for a middle-and-high-temperature stage is 6 min to 10 min.

6. The method for preparing the silky, fine-grained matte ceramic tile according to claim 5, wherein the desulfurized waste in step (1) is a desulfurized plaster produced by treating smoke from a ceramic tile kiln via a wet desulfurization process, a main component of the desulfurized plaster is calcium sulfate dihydrate CaSO₄.2H₂O, a major impurity is calcium carbonate; the desulfurized plaster has a purity of 90% to 95%, a water content of 10% to 15%, and a main particle size of 30 nm to 50 nm.

7. The method for preparing the silky, fine-grained matte ceramic tile according to claim 5, wherein the high-carbon mud in step (1) has a carbon content of ≥3.0%, it needs to be used in combination with the low-carbon mud, and it has a water content of 19% to 21%; the low-carbon mud has a carbon content of ≤0.5%, it can be used independently as a component of the raw materials, or in combination with a medium-high-carbon mud, and it has a water content of 17% to 20%.

8. The method for preparing the silky, fine-grained matte ceramic tile according to claim 5, wherein the glaze in step (8) is a silky matte glaze slurry consisting of a leveling agent and a fine-grained matte glaze slurry;
the leveling agent is one or more selected from the group consisted of a polyacrylic acid leveling agent, a phosphate ester modified acrylic acid leveling agent, a fluorine modified acrylic acid leveling agent, a butyl acrylate leveling agent, a silicone leveling agent, a polyether polyester modified silicone leveling agent, a polyether-modified silicone, a polymethylalkylsiloxane, an alkyl-modified organosiloxane, an end-group modified silicone, and a fluorocarbon leveling agent; the leveling agent is added in an amount of 0.1% to 0.5% in weight percentage;
the fine-grained matte glaze slurry is made from ball-milling 64%-74% of a matte glaze powder, 0.2%-1.2% of an additive, and 25%-35% of water in weight percentages for 5 to 8 hours; fineness of the fine-grained matte glaze slurry is controlled such that 0.8%-1.2% of the fine-grained matte glaze slurry is unable to pass a 325 mesh sieve.

9. The method for preparing the silky, fine-grained matte ceramic tile according to claim 8, wherein the matte glaze powder consists of the following components in weight percentages:
nepheline: 8%-13%;
albite: 5%-10%;
FMC633 frit: 10%-15%;
FMC689 frit: 28%-35%;
FMC053 frit: 8%-12%;
zinc phosphate: 2%-10%;
zinc oxide: 2%-6%;
wollastonite: 2%-5%;
aluminium oxide: 1%-7%;
bentonite: 0%-1%;
ultrafine zirconia: 0%-10%;
recycled material from scrapping: 5%-15%;
ball clay: 7%-10%;
carboxymethyl cellulose: 0.2%-0.3%;
sodium tripolyphosphate: 0.3%-0.5%.

10. The method for preparing the silky, fine-grained matte ceramic tile according to claim 9, wherein calcium and magnesium are introduced into a formulation of the FMC633 frit; the FMC633 frit comprises the following main chemical components in weight percentages:
I.L≤0.05;
SiO₂: 51.35;
Al₂O₃: 11.97;
Fe₂O₃: 0.05;
CaO: 17.92;
MgO: 8.25;
K₂O: 2.86;
Na₂O: 2.39;
ZrO₂: 5.16;
the FMC633 frit is a low-temperature frit which is conducive to formation of a smooth product glaze with a crystal-like gloss;
aluminium and calcium are introduced into a formulation of the FMC689 frit; the FMC689 frit comprises the following main chemical components in weight percentages:
I.L≤0.05;
SiO₂: 54.52;
Al₂O₃: 21.73;
Fe₂O₃: 0.07;
CaO: 15.11;
MgO: 0.23;
K₂O: 3.49;
Na₂O: 2.43;
B₂O₃: 1.89;
ZnO: 0.48;
the FMC689 frit is a high-temperature frit, which allows formation of a smooth product glaze and controls gloss of the product glaze;
zinc and zirconium are introduced into a formulation of the FMC053 frit; the FMC053 frit comprises the following main chemical components in weight percentages:
I.L≤0.05;
SiO₂: 44.67;
Al₂O₃: 16.36;
Fe₂O₃: 0.05;
CaO: 4.1;
MgO: 0.30;
K₂O: 1.76;
Na₂O: 2.72;
B₂O₃: 2.59;
ZnO: 15.03;
ZrO₂: 11.20;
P₂O₅: 1.17;
the FMC053 frit is a medium high-temperature frit, which allows formation of a smooth and fine product glaze and whitens the product glaze;
the recycled material from scrapping consists of a blank material and a glaze material, wherein the glaze material comprises a base glaze and a transparent glaze, the recycled material from scrapping has a water content of 9% to 13% and fineness of <1%;
the recycled material from scrapping comprises the following main chemical components in weight percentages:
IL.: 5-6;
SiO₂: 59-61;
Al₂O₃: 20-21;
Fe₂O₃: 0.1-0.2;
CaO: 4.5-5;
MgO: 3-3.8;
K₂O: 1-1.5;
Na₂O: 2.5-3;
ZrO₂: 0.2-0.8;
the ultrafine zirconia has a D50 value kept below 0.47 μm and a D90 value kept below 1.0 μm, ZrO₂≥93.27%, refractive index: 1.93 to 2.01, melting point: 2370 to 2700° C.
